(19) United States
(12) Patent Application Publication
(10) Pub. No.: US 2025/0191223 A1
(43) Pub. Date: Jun. 12, 2025

(54) ELECTRONIC DEVICE AND METHOD WITH VOXEL AND KEY POINT DETERMINATION

(71) Applicant: Samsung Electronics Co., Ltd., Suwon-si (KR)

(72) Inventors: Siyang PAN, Beijing (CN); Jiaqian YU, Beijing (CN); Seungin PARK, Suwon-si (KR); Sangil JUNG, Suwon-si (KR); Yiwei CHEN, Beijing (CN); Byung In YOO, Suwon-si (KR); Qiang WANG, Beijing (CN)

(73) Assignee: Samsung Electronics Co., Ltd., Suwon-si (KR)

(21) Appl. No.: 18/949,664

(22) Filed: Nov. 15, 2024

(30) Foreign Application Priority Data
Dec. 8, 2023 (CN) 202311687052.6
Aug. 20, 2024 (KR) 10-2024-0111525

(51) Int. Cl. G06T 7/73; G06V 10/77; G06V 10/82

(52) U.S. Cl. CPC G06T 7/74; G06V 10/7715; G06V 10/82; G06T 2207/10028

(57) ABSTRACT

A processor-implemented method includes determining either one or both of a first voxel and a first key point of point cloud data, and by performing feature transformation on either one or both of the first voxel and the first key point through a neural network, determining either one or both of a second voxel and a second key point of the point cloud data, wherein a voxel feature of the first voxel is different from a voxel feature of the second voxel, a key point feature of the first key point is different from a key point feature of the second key point, and either one or both of the second voxel and the second key point are used for training of the point cloud data.

### CROSS-REFERENCE TO RELATED APPLICATIONS

This application claims the benefit under 35 USC § 119(a) of Chinese Patent Application No. 202311687052.6 filed on Dec. 8, 2023, in the China National Intellectual Property Administration, and Korean Patent Application No. 10-2024-0111525 filed on Aug. 20, 2024, in the Korean Intellectual Property Office, the entire disclosures of which are incorporated herein by reference for all purposes.

### BACKGROUND

### 1. Field

The following description relates to an electronic device and method with voxel and key point determination.

### 2. Description of Related Art

An autonomous driving system may need to recognize objects and the surroundings of vehicles accurately and powerfully for a rational driving plan. For the accurate and strong recognition, three-dimensional (3D) object detection and 3D object tracking may be representative object recognition technologies. For the various object recognition technologies of the autonomous driving system, light detection and ranging (LiDAR), which is a type of a distance-measuring device, may be used. LiDAR may output high-quality 3D data and may be used in various object recognition methods.

Object recognition related to autonomous driving may rely on the training of deep models as deep learning and neural networks have advanced. The robustness of a model may be critical for the effective operation of the model in various scenarios. To build a highly robust model, large and diverse point cloud data may be required as training data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes determining either one or both of a first voxel and a first key point of point cloud data, and by performing feature transformation on either one or both of the first voxel and the first key point through a neural network, determining either one or both of a second voxel and a second key point of the point cloud data, wherein a voxel feature of the first voxel is different from a voxel feature of the second voxel, a key point feature of the first key point is different from a key point feature of the second key point, and either one or both of the second voxel and the second key point are used for training of the point cloud data.

The neural network may be implemented using an encoder and a decoder, and
the determining the second voxel and the second key point may include, by performing feature encoding on either one or both of the first voxel and the first key point through the encoder, determining either one or both of the voxel feature of the first voxel and the key point feature of the first key point, and by performing feature decoding on either one or both of the voxel feature of the first voxel and the key point feature of the first key point through the decoder, determining either one or both of the second voxel of the point cloud data and the second key point of the point cloud data.

The encoder may include a first encoder, and the determining the voxel feature of the first voxel may include, for each first voxel, by performing a convolution operation on the first voxel by using the first encoder, determining a first intermediate feature of the first voxel, and by downsampling the first intermediate feature, determining the voxel feature of the first voxel.

The convolution operation and the downsampling may be performed repeatedly, and a second intermediate feature determined through the downsampling may be input to a next convolution operation.

The encoder may include a first encoder, and the performing feature encoding on the first voxel may include, for each first voxel, determining the first key point corresponding to the first voxel, and performing feature encoding on the first voxel, based on the key point feature of the first key point, through the first encoder.

The encoder may include a second encoder, and the determining the key point feature of the first key point may include, for each first key point, determining a space comprising the first key point in the point cloud data, and by performing feature encoding on points in the space by using the second encoder, determining the key point feature of the first key point.

The encoder may include a second encoder, and the performing feature encoding on the first key point may include, for each first key point, determining a space comprising the first key point in the point cloud data, determining the first voxel comprised in the space, based on position information of the first key point, and performing feature encoding on the first key point, based on the first voxel, through the second encoder.

The decoder may include a first decoder, and the determining the second voxel of the point cloud data may include, by performing a convolution operation on the voxel feature of the first voxel by using the first decoder, determining a third intermediate feature, by upsampling the third intermediate feature, determining a fourth intermediate feature, and by pruning the fourth intermediate feature, determining the second voxel of the point cloud data.

The convolution operation, the upsampling, and the pruning may be performed repeatedly, and a fifth intermediate feature determined through the pruning may be input to a next convolution operation.

The performing feature encoding on the voxel feature of the first voxel may include determining position information of each second key point, based on the position information of each second key point, determining a voxel corresponding to each second key point, and for each second key point, in response to a voxel corresponding to the second key point not being comprised in the second voxel determined by the pruning, determining the voxel corresponding to the second key point as the second voxel of the point cloud data.

The decoder may include a second decoder, and the determining the second key point of the point cloud data may include performing feature decoding on either one or both of the voxel feature of the first voxel and the key point feature of the first key point through the decoder, based on the key point feature of the first key point, through the second decoder.

The performing feature decoding on the key point feature of the first key point may include determining valid position information of each second voxel, and, for each second key point, in response to position information of the second key point not coinciding with the valid position information of the second voxel corresponding to the second key point, adjusting the position of the second key point to the coordinate position of a point in a space formed by the second voxel, and the valid position information may include the coordinate position of each point in the space formed by the second voxel.

The point cloud data may represent an object in a surrounding space acquired through light detection and ranging (LiDAR) and the intensity of a light pulse reflected by the object.

A position of the first voxel in a multidimensional space may be different than a position of the second voxel in the multidimensional space, and an intensity of the first key point may be different than an intensity of the second key point.

In one or more general aspects, a non-transitory computer-readable storage medium may store instructions that, when executed by one or more processors, configure the one or more processors to perform any one, any combination, or all of operations and/or methods disclosed herein.

In one or more general aspects, an electronic device includes one or more processors configured to determine either one or both of a first voxel and a first key point of point cloud data, and by performing feature transformation on the first voxel and/or the first key point through a neural network, determine either one or both of a second voxel and a second key point of the point cloud data, wherein a voxel feature of the first voxel is different from a voxel feature of the second voxel, a key point feature of the first key point is different from a key point feature of the second key point, and either one or both of the second voxel and the second key point are used for training of the point cloud data.

The neural network may be implemented using an encoder and a decoder, and the one or more processors may be configured to, by performing feature encoding on either one or both of the first voxel and the first key point through the encoder, determine either one or both of the voxel feature of the first voxel and the key point feature of the first key point, and by performing feature decoding on either one or both of the voxel feature of the first voxel and the key point feature of the first key point through the decoder, determine either one or both of the second voxel of the point cloud data and the second key point of the point cloud data.

The encoder may include a first encoder, and the one or more processors may be configured to, for each first voxel, by performing a convolution operation on the first voxel by using the first encoder, determining a first intermediate feature of the first voxel, and by downsampling the first intermediate feature, determine the voxel feature of the first voxel.

The encoder may include a first encoder, and the one or more processors may be configured to, for each first voxel, determine the first key point corresponding to the first voxel, and perform feature encoding on the first voxel, based on the key point feature of the first key point, through the first encoder.

The encoder may include a second encoder, and the one or more processors may be configured to, for each first key point, determine a space comprising the first key point in the point cloud data, and by performing feature encoding on points in the space by using the second encoder, determine the key point feature of the first key point.

Other features and aspects will be apparent from the following detailed description, the drawings, and the claims.

### BRIEF DESCRIPTION OF THE DRAWINGS

FIG. 1 is a diagram illustrating an operation of a light detection and ranging (LiDAR) device according to one or more embodiments.

FIG. 2 is a diagram illustrating point cloud data acquired by an electronic device according to one or more embodiments.

FIG. 3 is a diagram illustrating an operation of mapping point cloud data to a two-dimensional (2D) image, according to one or more embodiments.

FIG. 4 is a diagram illustrating a voxel and a key point according to one or more embodiments.

FIG. 5 is a diagram illustrating an operation of determining a second voxel and a second key point according to one or more embodiments.

FIG. 6 is a diagram illustrating an operation of determining a second voxel according to one or more embodiments.

FIG. 7 is a diagram illustrating an operation of determining a second key point according to one or more embodiments.

FIG. 8 is a diagram illustrating an operation of determining a second voxel and a second key point by using voxel information and key point information, according to one or more embodiments.

FIG. 9 is a diagram illustrating an operation of determining a second key point by using voxel information, according to one or more embodiments.

FIG. 10 is a diagram illustrating an operation of determining a second voxel by using key point information, according to one or more embodiments.

FIG. 11 is a diagram illustrating an operation of determining a second voxel and a second key point by using voxel information and key point information, according to one or more embodiments.

FIG. 12 is a diagram illustrating an operation of encoding a voxel by using key point information, according to one or more embodiments.

FIG. 13 is a diagram illustrating an operation of decoding a key point by using voxel information according to one or more embodiments.

FIG. 14 is a flowchart illustrating an operating method of an electronic device according to one or more embodiments.

FIG. 15 is a block diagram illustrating an electronic device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. It will be further understood that terms, such as those defined in commonly used dictionaries, should be interpreted as having a meaning that is consistent with their meaning in the context of the relevant art and the disclosure of the present application, and will not be interpreted in an idealized or overly formal sense unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

At least some functions of an apparatus or an electronic device provided in one or more embodiments may be implemented through an artificial intelligence (AI) model. For example, at least one module among various modules of the apparatus or the electronic device may be implemented through the AI model. AI-related functions may be performed by a non-volatile memory, a volatile memory, and a processor.

The processor may include one or more processors. In this case, the one or more processors may be a general-purpose processor (e.g., a central processing unit (CPU), an application processor (AP), or a pure graphics processing unit (GPU), such as a GPU or a visual processing unit (VPU)), and/or an AI-only processor (e.g., a neural processing unit (NPU)).

The one or more processors may control the processing of input data according to a predefined operation rule or an AI model stored in the non-volatile memory and the volatile memory. The one or more processors may provide the predefined operation rule or the AI model through training or learning.

Here, ‘providing the predefined operation rule or the AI model through training or learning’ may refer to acquiring the predefined operation rule or the AI model with a desired feature by applying a learning algorithm to pieces of training data. The training may be performed by the apparatus or the electronic device itself, in which AI is performed, according to embodiments or by a separate server, device, and/or system.

The AI model may include a plurality of neural network layers. Each layer may perform a neural network operation by determining between input data (e.g., the determination result of a previous layer and/or input data of the AI model) of the layer or a plurality of weight values of a current layer. For example, a neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network, but embodiments are not limited thereto.

The learning algorithm may be a method of training a predetermined target device, for example, a robot, based on the pieces of training data and of enabling, allowing or controlling the target device to perform determination or prediction. The learning algorithm may include, for example, supervised learning, unsupervised learning, semi-supervised learning, or reinforcement learning, but embodiments are not limited thereto.

A method provided in one or more embodiments may be relevant to one or more technical fields, such as voice, language, image, video, and/or data intelligence.

In one or more embodiments, the AI model may be acquired through training. Here, ‘being acquired through training’ may refer to acquiring the predefined operation rule or the AI model with a desired feature (or objective) by training a basic AI model with the pieces of training data through the learning algorithm. The AI model may include a plurality of neural network layers. Each of the plurality of neural network layers includes a plurality of weights and may perform a neural network operation through an operation between the determination result of a previous layer and the plurality of weights.

Hereinafter, embodiments are described in detail with reference to the accompanying drawings. When describing the embodiments with reference to the accompanying drawings, like reference numerals refer to like elements and a repeated description related thereto is omitted.

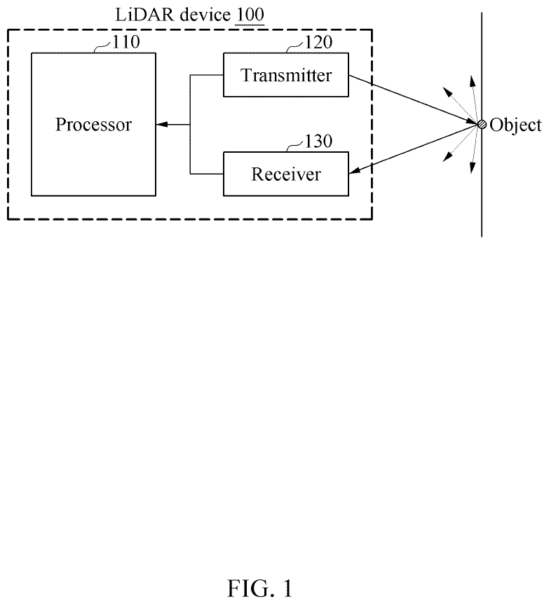

FIG. 1 is a diagram illustrating an operation of a light detection and ranging (LiDAR) device according to one or more embodiments.

Referring to FIG. 1, a LIDAR device 100 may include a processor 110 (e.g., one or more processors), a transmitter 120 (e.g., one or more transmitters), and a receiver 130.

An electronic device (e.g., the LiDAR device 100) may include various computing devices, such as a mobile phone, a smartphone, a tablet personal computer (PC), an e-book device, a laptop, a PC, a desktop, a workstation, and/or a server, various wearable devices, such as a smart watch, smart eyeglasses, a head-mounted display (HMD), and/or smart clothing, various home appliances, such as a smart speaker, a smart television (TV), and/or a smart refrigerator, and other devices, such as a smart vehicle, a smart kiosk, an Internet of things (IoT) device, a walking assist device (WAD), a drone, and/or a robot, but examples are not limited thereto. For ease of description, the electronic device may also be referred to as the LiDAR device 100 herein.

The transmitter 120 may generate and emit a light pulse, and the emitted light pulse may be reflected by an object. The receiver 130 may receive the light pulse reflected by the object. The receiver 130 may determine a propagation time from when the light pulse is emitted to when the light pulse is received by being reflected by the object.

The processor 110 may convert the propagation time into a distance based on the speed of light. For example, the processor 110 may determine a distance between the LiDAR device 100 and the object based on the determined propagation time and the speed of light. The processor 110 may determine three-dimensional (3D) spatial coordinates (e.g., x-, y-, and z-coordinates) of a point where the light pulse is reflected, based on an angle between the position of the LiDAR device 100 and the transmitter 120. The receiver 130 may determine the intensity of the received light pulse.

The processor 110 may generate point cloud data for a surrounding space by using the 3D spatial coordinates of the point where the light pulse is reflected. In addition, the processor 110 may generate the point cloud data based on the 3D spatial coordinates of the point where the light pulse is reflected and the intensity of the received light pulse. The point cloud data may be data including points representing specific points in a 3D coordinate system. In addition, the point cloud data may include the intensity of the light pulse for each point. The processor 110 may represent each point of the point cloud data as (x, y, z, i). Here, i denotes the intensity of the light pulse.

In one or more embodiments, the transmitter 120 may be implemented as a plurality of transmitters arranged in columns such that the plurality of transmitters may acquire data for a plurality of points in the surrounding space by rotating in a predetermined angular range (e.g., 0 to 360 degrees). The processor 110 may generate the point cloud data for points where light pulses are reflected, based on the data acquired from the plurality of transmitters. Here, each transmitter 120 may be different from the others and may have a different emission angle.

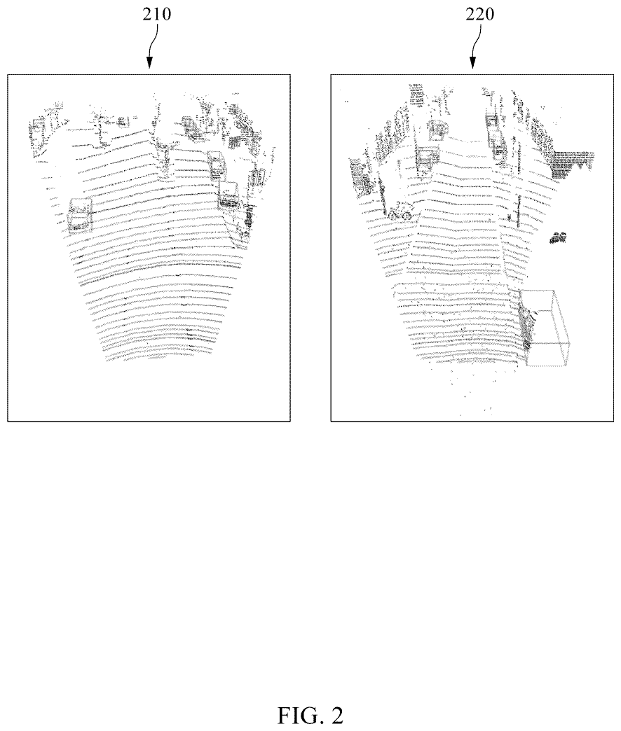

FIG. 2 is a diagram illustrating point cloud data acquired by an electronic device according to one or more embodiments.

FIG. 2 illustrates examples of point cloud data 210 acquired through LiDAR in clear weather and point cloud data 220 acquired through LiDAR in snowy weather. Although FIG. 2 only illustrates points acquired from the front of a LIDAR device for the description of the pieces of the point cloud data 210 and 220, embodiments are not limited thereto. Point cloud data may include points acquired from various angles around the LiDAR device. In the pieces of the point cloud data 210 and 220, the color of a point represents pulse intensity and a box represents a surrounding vehicle or a surrounding pedestrian.

The pieces of the point cloud data 210 and 220 may be acquired differently depending on situations even in the same space. For example, when the pieces of the point cloud data 210 and 220 correspond to a traffic situation scene, the pieces of the point cloud data 210 and 220 may be determined differently due to traffic volume, position, the weather, lighting, or other factors.

In addition, the form of point cloud data may be determined differently depending on scenarios. For example, as illustrated in FIG. 2, the pieces of the point cloud data 210 and 220 may be determined differently through LiDAR in clear weather and snowy weather, respectively. Referring to FIG. 2, the position distribution of points of the point cloud data 220 in snowy weather is more chaotic than that of the point cloud data 210 in clear weather, and the intensity distribution of the points may also vary. Accordingly, in an example, a different form of point cloud data may indicate a different position distribution of points and/or a different intensity distribution of the points of the point cloud data. The reason why the pieces of the point cloud data 210 and 220 is determined differently is that a raindrop or a snowflake in the air may block all or some of a light pulse emitted from a transmitter and some object points may be omitted, or a light pulse is attenuated, and the LiDAR may acquire the point of an object inaccurately. Accordingly, for the robustness of object recognition, various forms of the pieces of the point cloud data 210 and 220 may be acquired and labeled.

In various embodiments, the electronic device may convert the pieces of the point cloud data 210 and 220 into various forms or styles of point cloud data. Compared to the acquiring of new point cloud data as performed by a typical electronic device, by converting the already acquired point cloud data 210 and 220 into the various forms of point cloud data, the electronic device of one or more embodiments may reduce the costs of data acquisition. In addition, by converting the already acquired point cloud data 210 and 220 into the various forms of point cloud data, there is no need to reactivate the LiDAR device, and only the form of data is changed without the content of data being changed in the converted data. Thus, re-labeling may not be required. For example, the electronic device of one or more embodiments may convert the point cloud data from the scene of clear weather to the scene of snowy weather while maintaining the positions of intersections and the labels of surrounding vehicles, pedestrians, roads, or the like. In a downstream perception task, training data is multiplied, and the training data may be included in various forms or styles.

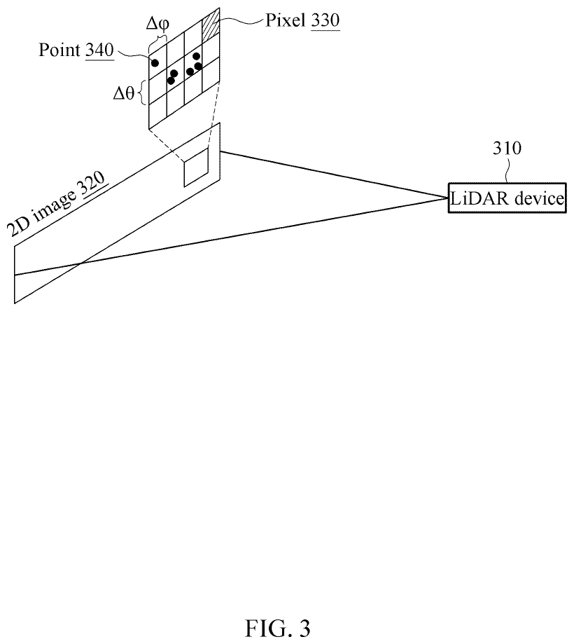

FIG. 3 is a diagram illustrating an operation of mapping point cloud data to a 2D image, according to one or more embodiments.

Referring to FIG. 3, a LIDAR device 310 may map acquired point cloud data to a 2D image 320.

The LiDAR device 310 may perform a method of converting the form of point cloud data and may use a physical optics-based method and a 2D projection-based method.

According to one or more embodiments, the LiDAR device 310 may use the principle of LIDAR and the influence of particles in the air on a light pulse as the physical optics-based method. In the physical optics-based method, the LiDAR device 310 may convert the form of point cloud data from clear weather to bad weather. For example, the LiDAR device 310 may model water molecules and/or snowflakes floating in the air in rainy, foggy, or snowy weather randomly. When the water molecules and/or snowflakes are modeled, the LiDAR device 310 may determine the simulated influence of water molecules and/or snowflakes on each light pulse emitted by a transmitter through physical optics modeling. Accordingly, the LiDAR device 310 may determine that the points of snowflakes and/or raindrops are determined inaccurately, the points of some objects are hidden by the particles in the air and disappear, the points of other objects are attenuated or scattered by the particles in the air, and/or spatial coordinates or pulse intensity may be changed by the snowflakes and/or raindrops. For example, the LiDAR device 310 may convert point cloud data in clear weather into point cloud data in bad weather through meteorology- and optics-based mathematical modeling and determination.

According to one or more embodiments, the LiDAR device 310 may use a cycle generative adversarial network (cycle GAN) for 2D data as the 2D projection-based method.

A GAN may include a generator and a discriminator. The generator may generate new data by using original data and cause the new data to have a new or different form from that of the original data. The discriminator may determine whether the data has a new form practically. The training of a model using a GAN may include two steps. In the first step, the discriminator may be fixed, and the generator may be trained. In this case, another generator may generate new data continuously and cause the discriminator to determine whether the new data has a new form. Through continuous training, the generator may be optimized continuously and may deceive the discriminator. For example, the discriminator may determine that the new data generated by the generator has a new form. Then, in the second step, the generator may be fixed, and the discriminator may be trained. In this case, the discriminator may be optimized continuously and may improve discrimination ability and may determine accurately that data generated by the generator does not have a new form. For example, the generator may no longer deceive the discriminator. Thus, the first step and the second step may be repeated continuously, the capabilities of the generator and the discriminator may be further improved gradually, and the finally acquired generator may generate data accurately in a new form.

According to one or more embodiments, the cycle GAN may include two pairs of a generator G_{AB} and a discriminator D_{B} and a generator G_{BA} and a discriminator D_{A}. The generator G_{AB} may generate data in a new form from an original form. The generator G_{BA} may generate data in the original form from the new form. The discriminator D_{A} may determine whether the data is the original form. The discriminator D_{B} may determine whether the data is the new form. In one or more embodiments, during the training based on the two steps, to not change the content of data when the generators G_{AB} and G_{BA} convert the form of the data, supervision information may be added. For example, when original data is x, the generator G_{AB} may convert x into G_{AB}(x). Then, the generator G_{BA} may convert G_{AB}(x) into G_{BA}(G_{AB}(x)) again. During the training, when the consistency of x and G_{BA}(G_{AB}(x)) is maintained, the generators G_{AB} and G_{BA} may not change the content of x with changing the form of x and may acquire G_{AB}(x) having a required new form.

The cycle GAN may be used for 2D image data. According to one or more embodiments, the LiDAR device 310 may project and map 3D point cloud data onto the 2D image 320 through the 2D projection-based method, may acquire 2D data in a new form by using the cycle GAN from the 2D image 320, and may map the acquired 2D data to the 3D point cloud data again. According to one or more embodiments, the LiDAR device 310 may map 3D point cloud data to 2D image data by using Equation 1 below, for example.

$$φ = {tan}^{- 1} ( \frac{y}{x} ) \qquad Equation 1$$

$$θ = {cos}^{- 1} ( \frac{z}{\sqrt{{x}^{2} + {y}^{2} + {z}^{2}}} )$$

$$r = \sqrt{{x}^{2} + {y}^{2} + {z}^{2}}$$

Here, when each point of the 3D point cloud data is represented by (x, y, z, i), x, y, and z denote the spatial positions of each point, and (φ, θ, r, i) denotes spherical coordinates into which (x, y, z, i), that is, Cartesian coordinates, is converted. According to one or more embodiments, the LiDAR device 310 may determine a zenith angle θ and an azimuth angle q for each point of the 3D point cloud data and may discretize the determined zenith and azimuth angles.

As illustrated in FIG. 3, the LiDAR device 310 may project each point 340 onto a pixel 330 of the 2D image 320 with Δθ and Δφ respectively as a unit width and a unit length. According to one or more embodiments, the 2D image 320 may have two channels, and a distance r and an intensity i of the pixel position of each channel may be stored.

The LiDAR device 310 may determine the channel characteristics of each pixel 330, based on data of points included in each pixel 330. According to one or more embodiments, in the 2D image 320, when a specific pixel 330 has one point 340, the LiDAR device 310 may determine the distance r and the intensity i of the point 340 as the channel characteristics of the pixel 330. In addition, when the specific pixel 330 does not have the point 340, the LiDAR device 310 may determine all the channel characteristics of the pixel 330 to have a first value (e.g., 0). In addition, when the specific pixel 330 includes a plurality of points, the LiDAR device 310 may determine an average value of the distances r and intensities i of the included plurality of points as the channel characteristics of the pixel 330.

According to one or more embodiments, the LiDAR device 310 may convert the form of the 2D image 320 by using the generator G_{AB} trained through the cycle GAN. In addition, the LIDAR device 310 may acquire 3D point cloud data in a new form by using an inverse operation of the projection operation described above.

According to one or more embodiments, the 2D projection-based method may use predetermined hyperparameters to project 3D data. For example, the predetermined hyperparameters may be used for Δθ and Δφ.

According to one or more embodiments, the 3D point cloud in a new form may be generated to train a downstream recognition task with more pieces of point cloud data simultaneously. For example, in 3D object detection, methods (e.g., voxel region-based CNN (R-CNN), VoteNet, or point-voxel region-based CNN (PVRCNN)) may convert unprocessed original 3D point cloud data into voxels or key points or into both the voxels and the key points first, and then, may input the voxels and/or key points to a neural network of the downstream recognition task. Thus, the 3D point cloud data in a new form may be converted into the voxels and the key points before being processed in the downstream recognition task.

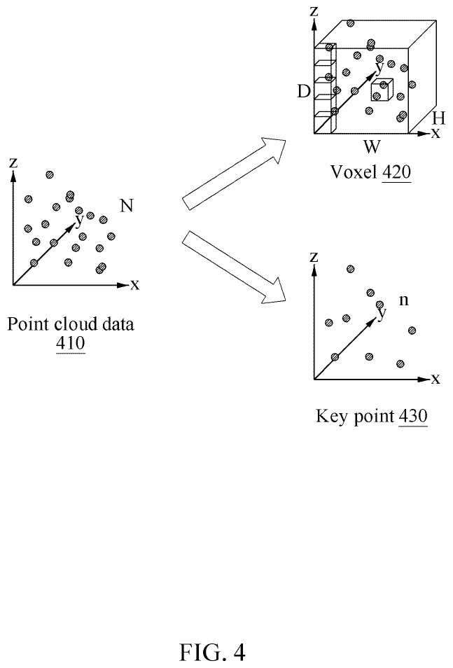

FIG. 4 is a diagram illustrating a voxel and a key point according to one or more embodiments.

FIG. 4 illustrates an example of voxels 420 and key points 430 into which point cloud data 410 is converted.

In unprocessed point cloud data 410, N points are distributed in a 3D space, and the information of each point may be expressed by (x, y, z, i). The 3D space may be subdivided into equally spaced 3D grids. In one or more embodiments, the voxels 420 may represent the subdivided 3D grids, respectively. As illustrated in FIG. 4, when the x-, y-, and z-axes of the 3D space are divided into W, H, and D parts, the space is divided into W*H*D small 3D grids. The small 3D grids may be the voxels 420, respectively. The information of each voxel 420 may be represented by (x, y, z, i), that is, four pieces of data, and may be determined differently depending on the information of arranged points.

In one or more embodiments, an electronic device may select multiple points as representatives for each voxel 420, may average the information of the selected points, and may use or determine an averaged value as the information of the voxel 420. Accordingly, the electronic device of one or more embodiments may convert the point cloud data 410 into a tensor of 4*W*H*D, and the tensor may cause a subsequent task of a neural network to be performed easier. In addition, in one or more embodiments, when the point cloud data 410 is sparse, the tensor from the conversion may maintain the sparse characteristic. For example, when most or a substantial portion of the information of the voxels 420 is empty, the electronic device may perform a sparse convolution task instead of a convolution task in a neural network of a recognition task.

According to one or more embodiments, the electronic device may select n points from among N points included in the point cloud data 410 and may determine the selected n points as the key points 430. In this case, the number N of points included in each point cloud data 410 may vary, but the electronic device may acquire a fixed number of key points 430 by selecting the n points. For example, the electronic device may ensure the uniform sampling of points by using farthest point sampling (FPS). The electronic device may acquire the fixed number of key points 430 for each point cloud data 410.

The electronic device may include a generative model that converts the voxels 420 and key points 430 for the point cloud data 410 from one form to another new form. In this case, without additional preprocessing in a downstream recognition task, the voxels and key points converted into a new form, may be used directly. In addition, the electronic device of one or more embodiments may generate a new form of data more rationally by using an interactive network that may align the voxels 420 with key point features and may perform the training of the downstream recognition task more powerfully.

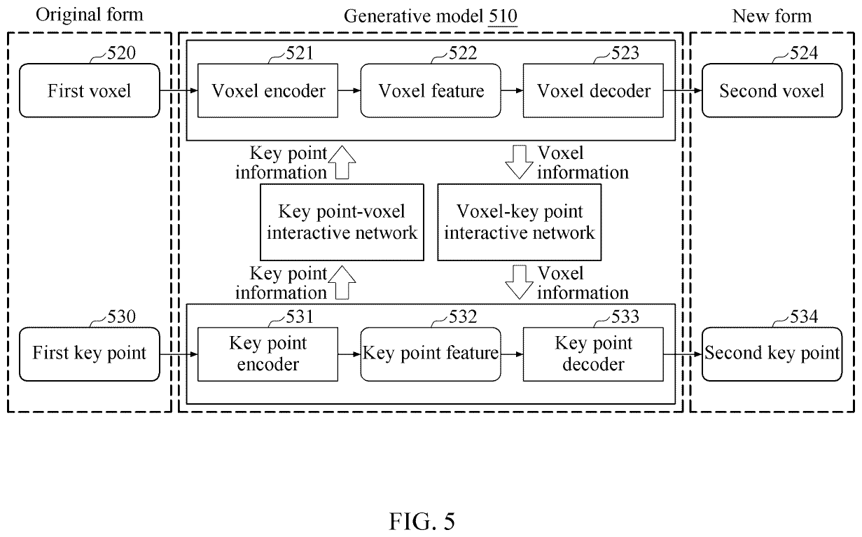

Example operations of the electronic device are described in detail below with reference to FIGS. 5 to 13.

FIG. 5 is a diagram illustrating an operation of determining a second voxel and a second key point according to one or more embodiments.

Referring to FIG. 5, an electronic device may convert a first voxel 520 in an original form and a first key point 530 in an original form respectively into a second voxel 524 in a new form and a second key point 534 in a new form by using a generative model 510. In an example, when the first voxel 520 in the original form is converted into the second voxel 524 in the new form, a position of the first voxel 520 in a multidimensional space (e.g., 3D space) may be different than a position of the second voxel 520 in the multidimensional space. Further, in an example, when the first key point 530 in the original form is converted into the second key point 534 in the new form, an intensity of the first key point 530 may be different than an intensity of the second key point 534. According to one or more embodiments, the generative model 510 may include or be implemented using a voxel encoder 521, a voxel decoder 523, a key point encoder 531, and a key point decoder 533.

As illustrated in FIG. 5, the generative model 510 may convert a voxel and a key point corresponding to each other from one form into another new form. According to one or more embodiments, the generative model 510 may be implemented by a neural network, but embodiments are not limited thereto. The electronic device may input the information (e.g., features) of voxels and/or key points for point cloud data in an original form to the generative model 510 and may acquire voxels and/or key points in a new form.

According to one or more embodiments, the generative model 510 may perform feature conversion on the first voxel 520 through the neural network and may determine the second voxel 524 based on a result of the feature conversion performed on the first voxel 520. In addition, the generative model 510 may perform feature conversion on the first key point 530 through the neural network and may determine the second key point 534 based on a result of the feature conversion performed on the first key point 530. In addition, the generative model 510 may perform feature conversion on the first voxel 520 and the first key point 530 through the neural network and may determine the second voxel 524 and the second key point 534 based on a result of the feature conversion performed on the first voxel 520 and the first key point 530. In this case, the voxel feature of the first voxel 520 may be different from the voxel feature of the second voxel 524. In addition, the key point feature of the first key point 530 may be different from the key point feature of the second key point 534.

According to one or more embodiments, generated second voxels and/or second key points may be used for the training of an AI model for point cloud data.

According to one or more embodiments, the generative model 510 may include two branches: a voxel branch and a key point branch that implement the form conversion of a voxel and a key point, respectively. The voxel branch may include the voxel encoder 521 and the voxel decoder 523. The key point branch may include the key point encoder 531 and the key point decoder 533.

In the voxel branch, the generative model 510 may acquire a voxel feature 522 by performing feature encoding on the first voxel 520 in an original form through the voxel encoder 521. Then, the generative model 510 may acquire the second voxel 524 in a new form by performing feature decoding on the voxel feature 522 through the voxel decoder 523. In one or more embodiments, the voxel encoder 521 and the voxel decoder 523 may be implemented through a neural network. For ease of description, the first voxel 520 may be referred to as an original voxel and the second voxel 524 may be referred to as a new voxel herein.

In the key point branch, the generative model 510 may acquire a key point feature 532 by performing feature encoding on the first key point 530 in an original form through the key point encoder 531. Then, the generative model 510 may acquire the second key point 534 in a new form by performing feature decoding on the key point feature 532 through the key point decoder 533. In one or more embodiments, the key point encoder 531 and the key point decoder 533 may be implemented through a neural network. For ease of description, the first key point 530 may be referred to as an original key point and the second key point 534 may be referred to as a new key point herein.

According to one or more embodiments, to improve the robustness of the second voxel 524 from the conversion and the second key point 534 from the conversion, a bidirectional interactive network may be added between the voxel branch of the generative model 510 and the key point branch of the generative model 510 such that the voxel feature 522 may be aligned with the key point feature 532. The first voxel 520 and the first key point 530 for each point cloud data may correspond to each other. Thus, the voxel feature 522 and the key point feature 532 for the point cloud data may also be aligned. Accordingly, the bidirectional interactive network may be added between the voxel branch and the key point branch of the generative model 510.

For example, when a space has a key point, there may be a valid (e.g., not empty by including the key point) voxel. Thus, the key point feature 532 may be expressed better (e.g., more accurately) by using the voxel feature 522. In addition, the voxel feature 522 may also be expressed better by using the key point feature 532. Accordingly, in one or more embodiments, a “key point-voxel interactive network” and a “voxel-key point interactive network” may be added between the voxel branch and the key point branch of the generative model 510. The key point-voxel interactive network may transmit key point information to the voxel branch, and the voxel-key point interactive network may transmit voxel information to the key point branch. In one or more embodiments, such interactive networks may be implemented through a neural network.

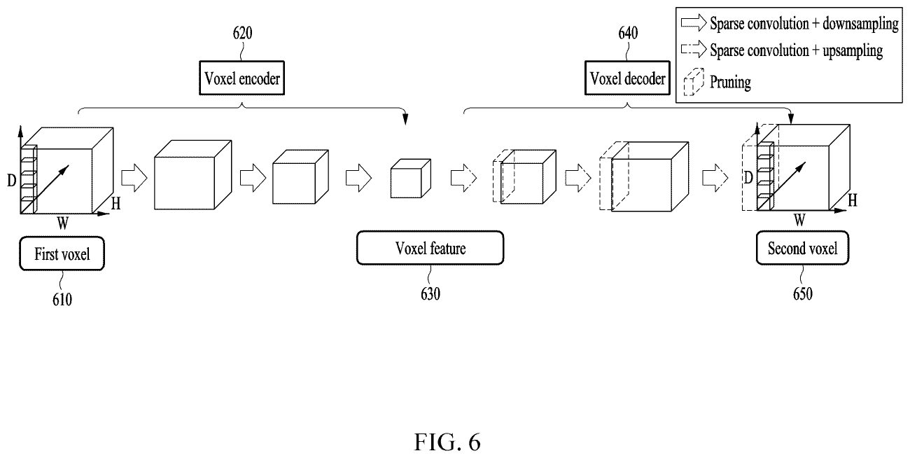

FIG. 6 is a diagram illustrating an operation of determining a second voxel according to one or more embodiments.

Referring to FIG. 6, in a voxel branch, a generative model may extract a voxel feature 630 from a first voxel 610 by using a voxel encoder 620 and may generate a second voxel 650 from the voxel feature 630 by using a voxel decoder 640. For ease of description, a first encoder may be referred to as the voxel encoder 620 and a first decoder may be referred to as the voxel decoder 640 herein.

According to one or more embodiments, the voxel encoder 620 may perform a convolution operation on the first voxel 610 and may determine a first intermediate feature of the first voxel 610. In one or more embodiments, when both the first voxel 610 and the second voxel 650 are sparse tensors, a convolution operation performed by the voxel encoder 620 and the voxel decoder 640 may be a sparse convolution operation. For example, when both the first voxel 610 and the second voxel 650 are sparse tensors of 4*W*H*D, the convolution operation performed by the voxel encoder 620 and the voxel decoder 640 may be a sparse convolution operation. Here, W, H, and D may be predetermined according to embodiments.

According to one or more embodiments, the voxel encoder 620 may downsample the first intermediate feature and may determine the voxel feature 630 of the first voxel 610. For example, the voxel encoder 620 may perform a sparse convolution operation and downsampling on the first voxel 610. In one or more embodiments, the voxel encoder 620 may perform the downsampling following the sparse convolution operation. In addition, the voxel encoder 620 may perform the convolution and downsampling operations repeatedly to generate the voxel feature 630. In this case, a second intermediate feature determined through the downsampling may be input to a next convolution operation. In this case, when all the repeated operations of the voxel encoder 620 are performed, the second intermediate feature may be determined as the voxel feature 630. The downsampling may decrease the feature size of the voxel encoder 620 gradually such that the voxel feature 630 extracted by the voxel encoder 620 may include the semantic information of the whole scene. The number of sparse convolution operations may be predetermined. In addition, the downsampling may be performed after each sparse convolution operation.

According to one or more embodiments, the voxel decoder 640 may perform a convolution operation on the voxel feature 630 and may determine a third intermediate feature. In addition, the voxel decoder 640 may upsample the third intermediate feature to determine a fourth intermediate feature and may prune the fourth intermediate feature to determine the second voxel 650. For example, the voxel decoder 640 may perform a sparse convolution operation and upsampling on the voxel feature 630. In one or more embodiments, the voxel decoder 640 may perform the upsampling following the sparse convolution operation. The upsampling may return the feature size to the original size gradually. According to one or more embodiments, the voxel decoder 640 may perform the convolution, upsampling, and pruning operations repeatedly. A fifth intermediate feature determined through the pruning may be input to a next convolution operation. In this case, when all the repeated operations of the voxel decoder 640 are performed, the fifth intermediate feature may be determined as the second voxel 650. When sparse convolution operations and upsampling are performed in the voxel decoder 640, the sparsity of features may be damaged. For example, as the feature size increases gradually, the ratio of voxels that are not empty (e.g., not 0) may increase gradually. Accordingly, the generated second voxel 650 may no longer be sparse, and a subsequent sparse convolution throughput may increase. Thus, by performing pruning after each upsampling, and resetting some voxels that are not empty to 0, the voxel decoder 640 of one or more embodiments may ensure the sparsity of features. For example, the voxel decoder 640 may acquire the second voxel 650 after performing pruning. For ease of description, the pruning may also be referred to as a pruning operation or a resetting operation herein.

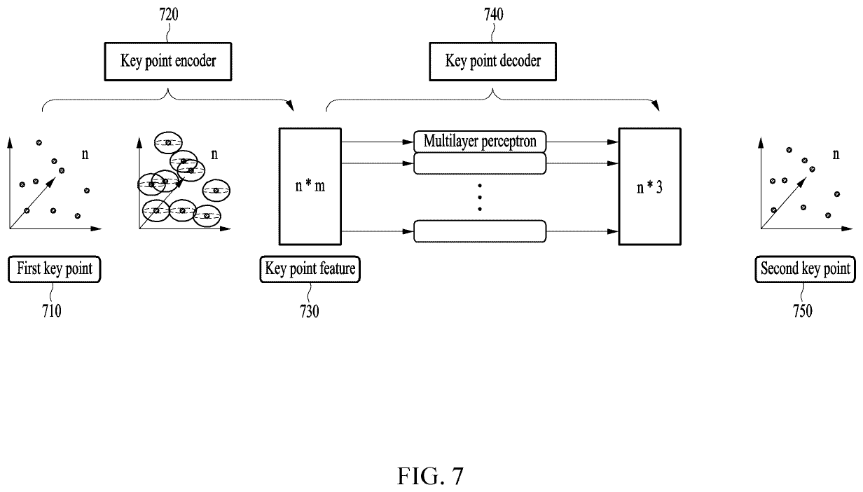

FIG. 7 is a diagram illustrating an operation of determining a second key point according to one or more embodiments.

Referring to FIG. 7, in a key point branch, a generative model may extract a key point feature 730 from a first key point 710 by using a key point encoder 720 and may generate a second key point 750 from the key point feature 730 by using a key point decoder 740. For ease of description, a second encoder may be referred to as the key point encoder 720 and a second decoder may be referred to as the key point decoder 740 herein.

In one or more embodiments, the number of points of the first key point 710 and the second key point 750 may be predetermined. For example, the number of points of the first key point 710 and the second key point 750 may be determined to be n.

The key point encoder 720 may determine a local spherical space in a preset radius around each key point. For ease of description, the local spherical space may be referred to as a local spherical region herein. In one or more embodiments, the key point encoder 720 may perform set abstraction in each determined spherical space. For example, the key point encoder 720 may encode features in a spherical space for the first key point 710. For example, the key point encoder 720 may encode only the features of key points included in a spherical space, may extract and fuse the features of non-key points and the key points included in the spherical space, and/or may determine a weight and perform weighted summation and average operations on the features of the key points and the features of the non-key points. Here, the non-key points may be points that are not key points in point cloud data. However, the operations of the key point encoder 720 described above are examples for description, but embodiments are not limited thereto. The key point encoder 720 may perform various set abstraction operations. Through set abstraction, each key point may be abstracted into a feature vector of a 1*m size. In this case, an output of the key point encoder 720 may be a matrix of an n*m size of. Here, m may be predetermined according to embodiments.

The key point decoder 740 may include n multilayer perceptrons (MLPs) that share weights. Here, n may be predetermined according to embodiments. In one or more embodiments, n MLPs may determine each of n feature vectors corresponding respectively to the n MLPs, may acquire n 1*3 feature vectors, and may correspond respectively to x-, y-, and z-coordinates of key points corresponding respectively to the n 1*3 feature vectors. In this case, the number of elements included in feature vectors is an example for description, but embodiments are not limited thereto. The number of elements included in the feature vectors may be predetermined to be different numbers.

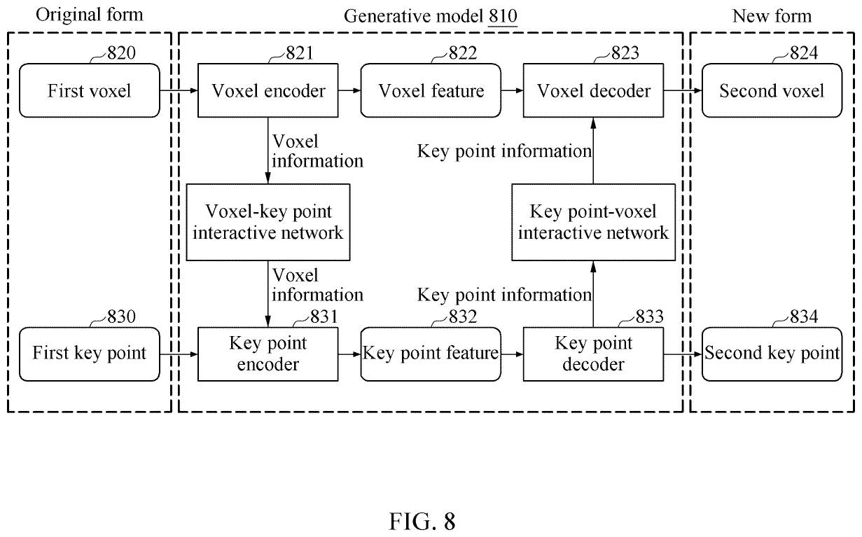

FIG. 8 is a diagram illustrating an operation of determining a second voxel and a second key point by using voxel information and key point information, according to one or more embodiments.

Referring to FIG. 8, in a generative model 810, a voxel-key point interactive network positioned between a voxel encoder 821 and a key point encoder 831 may transmit voxel information to a key point branch, and a key point-voxel interactive network positioned between a key point decoder 833 and a voxel decoder 823 may transmit key point information to a voxel branch. In one or more embodiments, the voxel-key point interactive network and the key point-voxel interactive network may be implemented through a neural network.

Since a first voxel 820, the voxel encoder 821, a voxel feature 822, a second voxel 824, a first key point 830, a key point feature 832, the key point decoder 833, and a second key point are described above in detail, repeated descriptions thereof are omitted.

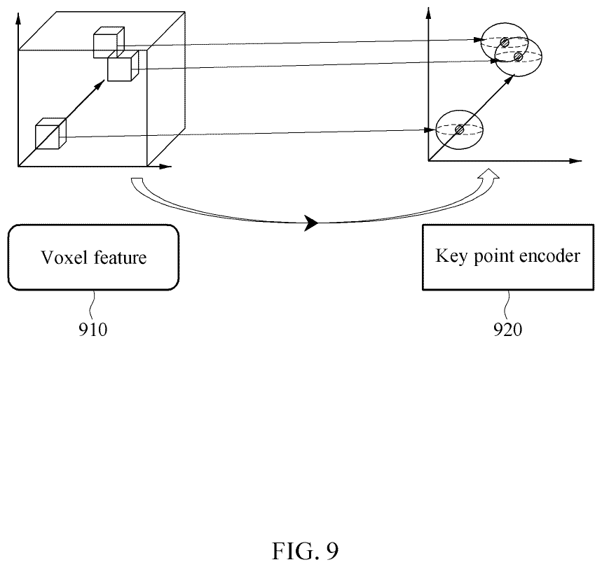

According to one or more embodiments, the key point encoder 831 may encode the feature of the first key point 830 based on voxel information received through the voxel-key point interactive network. An example of the operation of the key point encoder 831 performing feature encoding by using the voxel information is described in detail below with reference to FIG. 9.

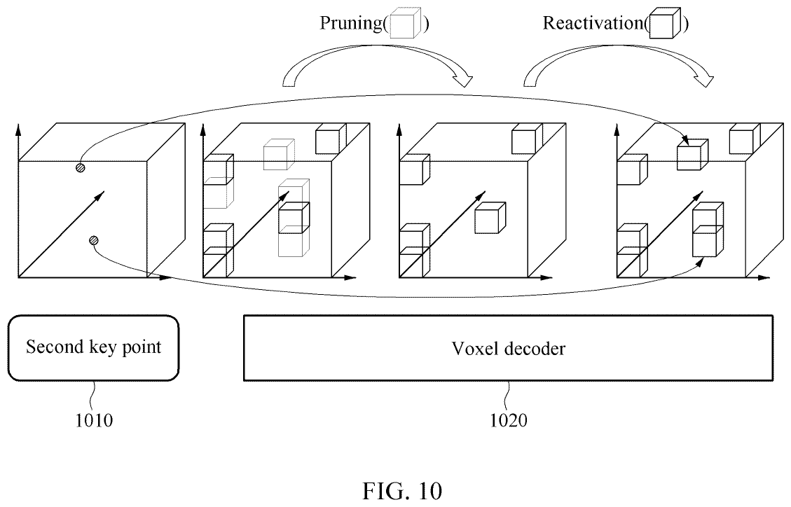

According to one or more embodiments, the voxel decoder 823 may process decoded voxels based on key point information received through the key point-voxel interactive network. An example of the operation of the voxel decoder 823 processing the decoded voxels by using the key point information is described in detail below with reference to FIG. 10.

FIG. 9 is a diagram illustrating an operation of determining a second key point by using voxel information, according to one or more embodiments.

Referring to FIG. 9, a key point encoder 920 may perform set abstraction by using a voxel feature 910 of a spatial position corresponding to a key point. In one or more embodiments, according to set abstraction, each key point may be abstracted into a feature vector. For example, each key point may be abstracted into a feature vector of a 1*m size.

According to one or more embodiments, the key point encoder 920 may generate a sphere with the key point as the center, may correspond the generated sphere to a voxel of the voxel feature 910, and may perform set abstraction. For example, when the spatial coordinates of the key point are (x₀, y₀, z₀), the key point encoder 920 may generate a sphere of a radius R with the key point as the center, and may arrange the generated sphere (x−x₀)²+(y−y₀)²+(z−z₀)²=R² in the same spatial position in a coordinate system of the voxel feature 910. A voxel included in the arranged sphere may be a voxel corresponding to the key point. When the sphere includes a total of k voxels (here, k is 1 in the example of FIG. 9), the key point encoder 920 may extract a feature vector from the key point by using the voxel feature 910 of the k voxels included in the key point encoder 920. For example, the key point encoder 920 may perform set abstraction on the key point, based on the voxel feature 910 of the k voxels, and may generate a feature vector (e.g., the feature vector of a 1*m size). For example, after determining an average for the voxel feature 910 of the k voxels, the key point encoder 920 may input the determined average to a linear layer and/or process the determined average by using PointNet. Through this, the operation of transmitting a voxel feature to a key point branch may be implemented.

In one or more embodiments, by using the feature encoding example of a key point of FIG. 7 with the voxel feature 910, for voxels and/or points (e.g., key points and/or non-key points) included in the generated sphere centered on the key point, the key point encoder 920 may extract a 1*m feature vector of the key point.

FIG. 10 is a diagram illustrating an operation of determining a second voxel by using key point information, according to one or more embodiments.

Referring to FIG. 10, a voxel decoder 1020 may use the spatial coordinates of a second key point 1010. After performing a pruning operation, when voxels corresponding to the second key point 1010 are pruned, the voxel decoder 1020 may activate voxels corresponding to the position of the second key point 1010 again.

In one or more embodiments, the voxel decoder 1020 may empty some voxels that are not empty by performing a pruning operation after each upsampling. However, there should be a valid (i.e., not empty) voxel in a position where a space has a key point. To prevent the voxels of the coordinate position corresponding to the second key point 1010 from being pruned, a key point decoder may determine the coordinates of the second key point 1010. Then, when the spatial coordinates of a specific second key point 1010 is (x₀, y₀, z₀), this new key point may be arranged in the same spatial position in a coordinate system of a voxel feature. When a voxel positioned in the spatial position is pruned, the voxel decoder 1020 may reactivate a voxel pruned in a subsequent reactivation operation. According to one or more embodiments, when a voxel corresponding to the second key point 1010 is pruned, the voxel may be reset as a non-empty voxel, and the non-empty voxel may have a corresponding original voxel feature or a voxel feature decoded before pruning.

Accordingly, a generative model may transmit key point information to a voxel branch, and also may align a voxel generated by the generative model with a key point.

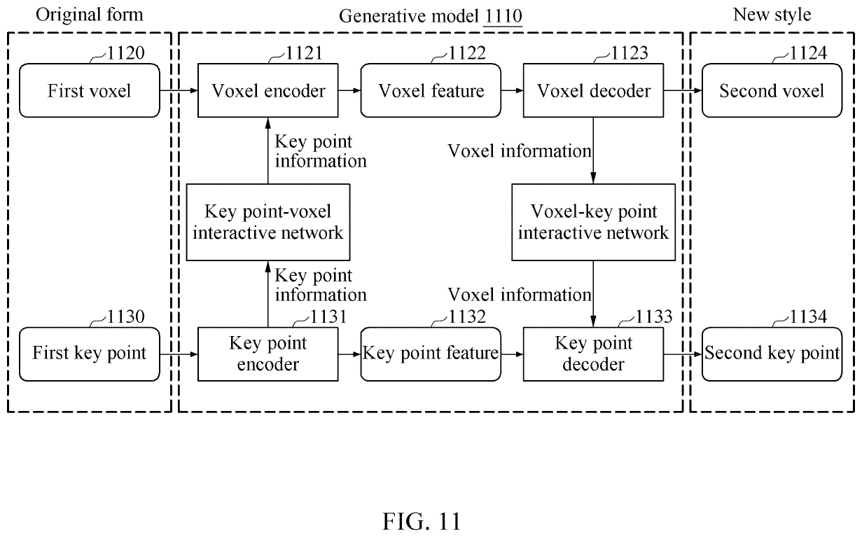

FIG. 11 is a diagram illustrating an operation of determining a second voxel and a second key point by using voxel information and key point information, according to one or more embodiments.

Referring to FIG. 11, a key point-voxel interactive network positioned between a key point encoder 1131 and a voxel encoder 1121 may transmit key point information to a voxel branch, and a voxel-key point interactive network positioned between a voxel decoder 1123 and a key point decoder 1133 may transmit voxel information to a key point branch. In one or more embodiments, the key point-voxel interactive network and the voxel-key point interactive network may be implemented through a neural network. In addition, according to the connectivity between an interactive network and an encoder or a decoder, the interactive network may be trained differently from the encoder and the decoder.

Since a first voxel 1120, the voxel encoder 1121, a voxel feature 1122, a second voxel 1124, a first key point 1130, a key point feature 1132, the key point decoder 1133, and a second key point are described above in detail, repeated descriptions thereof are omitted.

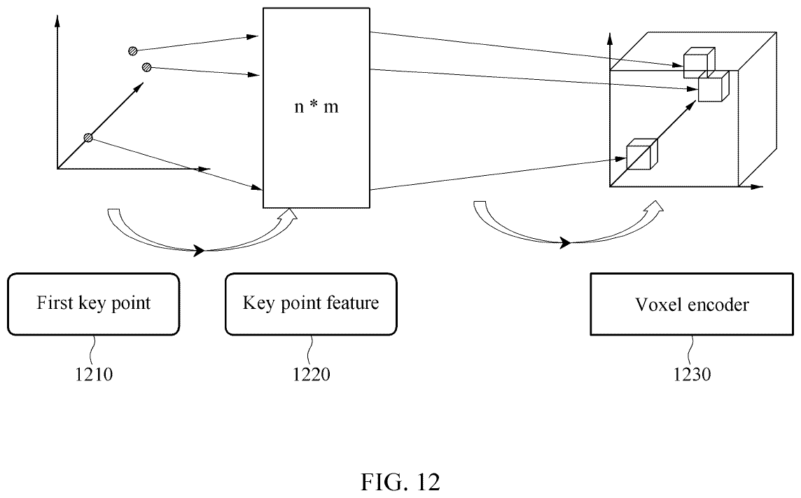

According to one or more embodiments, the voxel encoder 1121 may encode the feature of the first voxel 1120 based on key point information received through the key point-voxel interactive network. An example of the operation of the voxel encoder 1121 performing feature encoding by using the key point information is described in detail below with reference to FIG. 12.

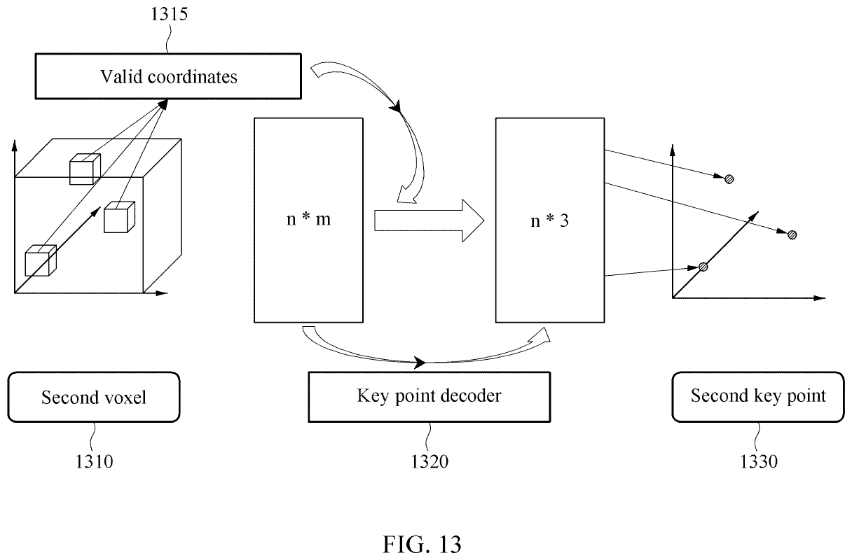

According to one or more embodiments, the key point decoder 1133 may process decoded key points based on voxel information received through the voxel-key point interactive network. An example of the operation of the key point decoder 1133 processing the decoded key points by using the voxel information is described in detail below with reference to FIG. 13.

FIG. 12 is a diagram illustrating an operation of encoding a voxel by using key point information, according to one or more embodiments.

Referring to FIG. 12, a key point encoder may extract a key point feature 1220 by using spatial coordinates (e.g., x, y, and z) of each first key point 1210 through set abstraction. In one or more embodiments, when the spatial coordinates of a specific key point is (x₀, yₒ, z₀), the key point encoder may treat the spatial coordinates as a vector of a specific size (e.g., 1*3) and may perform an operation (e.g., using a linear layer or processing PointNet) on the vector. The key point encoder may acquire one 1*m vector finally for the point. For example, when there are n key points, the key point encoder may acquire n*m key point features 1220.

According to one or more embodiments, for each key point, a voxel encoder 1230 may arrange the key point in the same position in a coordinate system of a voxel feature, based on the coordinates of the key point. For example, when a key point (x₀, y₀, z₀) is arranged in the same coordinate position in the coordinate system of the voxel feature, the voxel encoder 1230 may fuse (e.g., sum or stitch) the voxel feature of the position with a 1*m vector of the key point. Through this, the operation of transmitting the key point feature 1220 to a voxel branch may be implemented.

FIG. 13 is a diagram illustrating an operation of decoding a key point by using voxel information according to one or more embodiments.

Referring to FIG. 13, a key point decoder 1320 may correct a second key point 1330 to a valid coordinate position by using valid coordinates 1315, that is, spatially valid coordinates, in a second voxel 1310.

In one or more embodiments, the second voxel 1310 output by a voxel decoder is a sparse tensor, most of the second voxel 1310 may be empty, and only some of the second voxel 1310 may have valid coordinates. However, there should be a valid (i.e., not empty) voxel in a position where a space has a key point. To prevent the key point decoder 1320 from generating the second key point 1330 in a position having invalid coordinates, the voxel decoder may store a valid coordinate position (e.g., a coordinate position of each point in a space formed by voxels) when determining the second voxel 1310. When the second key point 1330 generated by the key point decoder 1320 is in invalid coordinates (e.g., when the second key point 1330 is not in a coordinate position of each point in a space formed by the second voxel 1310), the key point decoder 1320 may correct the position of the key point to the stored valid coordinate position. For example, the key point decoder 1320 may force the key point to move to valid coordinates closest to the key point or may repeatedly perform the operation of the key point decoder 1320 until a new key point is in valid coordinates. By doing so, voxel information may be transmitted to a key point branch, and, at the same time, a voxel generated by a generative model may be aligned with a key point.

According to various embodiments, an electronic device may prevent voxels or key points from disappearing. In addition, the electronic device may implement the alignment between voxel data and key point data and may enhance the robustness of voxels and key points from the conversion.

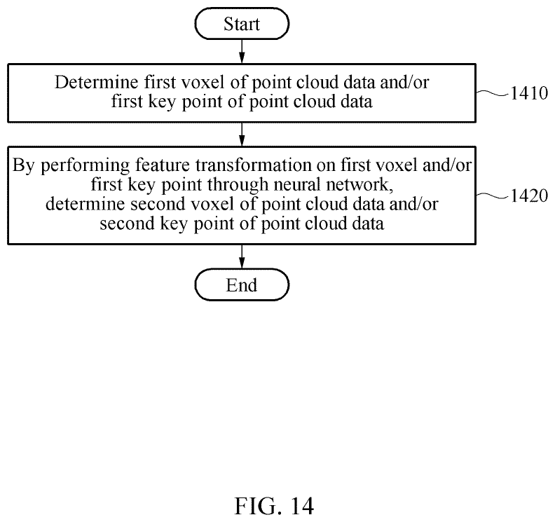

FIG. 14 is a flowchart illustrating an operating method of the electronic device according to one or more embodiments.

In the following embodiments, operations may be performed sequentially but not necessarily. For example, the order of the operations may be changed and at least two of the operations may be performed in parallel. Operations 1410 and 1420 may be performed by at least one component (e.g., a processor) of an electronic device.

In operation 1410, the electronic device may determine a first voxel of point cloud data and/or a first key point of the point cloud data.

In operation 1420, the electronic device, by performing feature transformation on the first voxel and/or the first key point through a neural network, may determine a second voxel of the point cloud data and a second key point of the point cloud data. The neural network may include an encoder and a decoder. In addition, the encoder may include a first encoder and a second encoder, and the decoder may include a first decoder and a second decoder. Further, in operation 1420, the electronic device may train the point cloud data using the second voxel and/or the second key point.

The electronic device, by performing feature encoding on the first voxel and/or the first key point through the encoder, may determine the voxel feature of the first voxel and/or the key point feature of the first key point, and, by performing feature decoding on the voxel feature of the first voxel and/or the key point feature of the first key point through the decoder, may determine the second voxel and/or second key point of point cloud data. The electronic device, for each first voxel, by performing a convolution operation on the first voxel by using the first encoder, may determine a first intermediate feature of the first voxel, and, by downsampling the first intermediate feature, may determine the voxel feature of the first voxel. The electronic device, for each first voxel, may determine the first key point corresponding to the first voxel and may perform feature encoding on the first voxel, based on the key point feature of the first key point, through the first encoder.

The electronic device, for each first key point, may determine a space including the first key point in the point cloud data, and, by performing feature encoding on points in the space by using the second encoder, may determine the key point feature of the first key point. The electronic device, for each first key point, may determine a space including the first key point in the point cloud data, may determine the first voxel included in the space, based on the position information of the first key point, and may perform feature encoding on the first key point, based on the first voxel, through the second encoder. The electronic device may determine a third intermediate feature by performing a convolution operation on the voxel feature of the first voxel by using the first decoder, may determine a fourth intermediate feature by upsampling the third intermediate feature, and may determine the second voxel of the point cloud data by pruning the fourth intermediate feature. The electronic device may determine the position information of each second key point, based on the position information of each second key point, may determine a voxel corresponding to each second key point, and, for each second key point, when a voxel corresponding to the second key point is not included in the second voxel determined by the pruning, may determine the voxel corresponding to the second key point as the second voxel of the point cloud data. The electronic device may perform feature decoding, based on the key point feature of the first key point, through the second decoder. The electronic device may determine the valid position information of each second voxel, and, for each second key point, when the position information of the second key point does not coincide with the valid position information of the second voxel corresponding to the second key point, may adjust the position of the second key point to the coordinate position of a point in a space formed by the second voxel.

The voxel feature of the first voxel is different from the voxel feature of the second voxel, the key point feature of the first key point is different from the key point feature of the second key point, and/or the second voxel and/or the second key point may be used for training of the point cloud data. The convolution operation and downsampling may be performed repeatedly, and a second intermediate feature determined through the downsampling may be input to a next convolution operation. The convolution operation, the upsampling, and the pruning may be performed repeatedly, and a fifth intermediate feature determined through the pruning may be input to a next convolution operation. The valid position information may include the coordinate position of each point in the space formed by the second voxel. The point cloud data may represent an object in a surrounding space acquired through LiDAR and the intensity of a light pulse reflected by the object.

The descriptions provided with reference to FIGS. 1 to 13 may be applicable to each operation shown in FIG. 14, and thus, detailed descriptions thereof have been omitted.

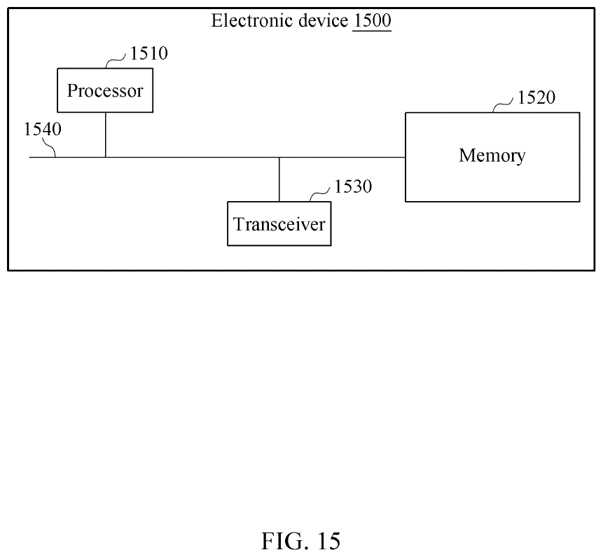

FIG. 15 is a block diagram illustrating an electronic device according to an embodiment.

Referring to FIG. 15, an electronic device 1500 may include a processor 1510 (e.g., one or more processors). The processor 1510 may include at least one processor. The electronic device 1500 may further include a memory 1520 (e.g., one or more memories). In addition, the electronic device 1500 may further include a transceiver 1530 for LiDAR. The processor 1510, the memory 1520, and the transceiver 1530 may be connected to one another via, for example, a bus 1540.

The memory 1520 may store instructions (or programs) executable by the processor 1510. For example, the instructions may include instructions for executing an operation of the processor 1510 and/or an operation of each component of the processor 1510. For example, the memory 1520 may be or include a non-transitory computer-readable storage medium storing instructions that, when executed by the processor 1510, configure the processor 1510 to perform any one, any combination, or all of the operations and/or methods disclosed herein with reference to FIGS. 1-14.

The processor 1510 may be a device that executes instructions or programs or controls the electronic device 1500 and may include, for example, various processors, such as a CPU and a GPU. The processor 1510 may determine a first voxel of point cloud data and/or a first key point of the point cloud data. The processor 1510, by performing feature transformation on the first voxel and/or the first key point through a neural network, may determine a second voxel of the point cloud data and a second key point of the point cloud data.

The processor 1510, by performing feature encoding on the first voxel and/or the first key point through the encoder, may determine the voxel feature of the first voxel and/or the key point feature of the first key point, and, by performing feature decoding on the voxel feature of the first voxel and/or the key point feature of the first key point through the decoder, may determine the second voxel and/or second key point of point cloud data. The processor 1510, for each first voxel, by performing a convolution operation on the first voxel by using the first encoder, may determine a first intermediate feature of the first voxel, and, by downsampling the first intermediate feature, may determine the voxel feature of the first voxel. The processor 1510, for each first voxel, may determine the first key point corresponding to the first voxel and may perform feature encoding on the first voxel, based on the key point feature of the first key point, through the first encoder. The processor 1510, for each first key point, may determine a space including the first key point in the point cloud data, and, by performing feature encoding on points in the space by using the second encoder, may determine the key point feature of the first key point. The processor 1510, for each first key point, may determine a space including the first key point in the point cloud data, may determine the first voxel included in the space, based on the position information of the first key point, and may perform feature encoding on the first key point, based on the first voxel, through the second encoder.

In addition, the electronic device 1500 may process the operations described above.

The LiDAR devices, processors, transmitters, receivers, voxel encoders, voxel decoders, key point encoders, key point decoders, electronic devices, memories, transceivers, LiDAR device 100, processor 110, transmitter 120, receiver 130, LiDAR device 310, voxel encoder 521, voxel decoder 523, key point encoder 531, key point decoder 533, voxel encoder 620, voxel decoder 640, key point encoder 720, key point decoder 740, voxel encoder 821, voxel decoder 823, key point encoder 831, key point decoder 833, voxel feature 910, key point encoder 920, voxel decoder 1020, voxel encoder 1121, voxel decoder 1123, key point encoder 1131, key point decoder 1133, voxel encoder 1230, key point decoder 1320, electronic device 1500, processor 1510, memory 1520, and transceiver 1530 described herein, including descriptions with respect to respect to FIGS. 1-15, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-15 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
determining either one or both of a first voxel and a first key point of point cloud data; and
by performing feature transformation on either one or both of the first voxel and the first key point through a neural network, determining either one or both of a second voxel and a second key point of the point cloud data,
wherein a voxel feature of the first voxel is different from a voxel feature of the second voxel, a key point feature of the first key point is different from a key point feature of the second key point, and either one or both of the second voxel and the second key point are used for training of the point cloud data.

2. The method of claim 1, wherein
the neural network is implemented using an encoder and a decoder, and
the determining the second voxel and the second key point comprises:
by performing feature encoding on either one or both of the first voxel and the first key point through the encoder, determining either one or both of the voxel feature of the first voxel and the key point feature of the first key point; and
by performing feature decoding on either one or both of the voxel feature of the first voxel and the key point feature of the first key point through the decoder, determining either one or both of the second voxel of the point cloud data and the second key point of the point cloud data.

3. The method of claim 2, wherein
the encoder comprises a first encoder, and
the determining the voxel feature of the first voxel comprises:
for each first voxel, by performing a convolution operation on the first voxel by using the first encoder, determining a first intermediate feature of the first voxel; and
by downsampling the first intermediate feature, determining the voxel feature of the first voxel.

4. The method of claim 3, wherein
the convolution operation and the downsampling are performed repeatedly, and
a second intermediate feature determined through the downsampling is input to a next convolution operation.

5. The method of claim 2, wherein
the encoder comprises a first encoder, and
the performing feature encoding on the first voxel comprises:
for each first voxel, determining the first key point corresponding to the first voxel; and
performing feature encoding on the first voxel, based on the key point feature of the first key point, through the first encoder.

6. The method of claim 2, wherein
the encoder comprises a second encoder, and
the determining the key point feature of the first key point comprises:
for each first key point, determining a space comprising the first key point in the point cloud data; and
by performing feature encoding on points in the space by using the second encoder, determining the key point feature of the first key point.

7. The method of claim 2, wherein
the encoder comprises a second encoder, and
the performing feature encoding on the first key point comprises:
for each first key point, determining a space comprising the first key point in the point cloud data;
determining the first voxel comprised in the space, based on position information of the first key point; and
performing feature encoding on the first key point, based on the first voxel, through the second encoder.

8. The method of claim 2, wherein
the decoder comprises a first decoder, and
the determining the second voxel of the point cloud data comprises:
by performing a convolution operation on the voxel feature of the first voxel by using the first decoder, determining a third intermediate feature;
by upsampling the third intermediate feature, determining a fourth intermediate feature; and
by pruning the fourth intermediate feature, determining the second voxel of the point cloud data.

9. The method of claim 8, wherein
the convolution operation, the upsampling, and the pruning are performed repeatedly, and
a fifth intermediate feature determined through the pruning is input to a next convolution operation.

10. The method of claim 8, wherein the performing feature encoding on the voxel feature of the first voxel comprises:
determining position information of each second key point;
based on the position information of each second key point, determining a voxel corresponding to each second key point; and
for each second key point, in response to a voxel corresponding to the second key point not being comprised in the second voxel determined by the pruning, determining the voxel corresponding to the second key point as the second voxel of the point cloud data.

11. The method of claim 2, wherein
the decoder comprises a second decoder, and
the determining the second key point of the point cloud data comprises performing feature decoding on either one or both of the voxel feature of the first voxel and the key point feature of the first key point through the decoder, based on the key point feature of the first key point, through the second decoder.

12. The method of claim 11, wherein
the performing feature decoding on the key point feature of the first key point comprises:
determining valid position information of each second voxel; and
for each second key point, in response to position information of the second key point not coinciding with the valid position information of the second voxel corresponding to the second key point, adjusting the position of the second key point to the coordinate position of a point in a space formed by the second voxel, and
the valid position information comprises the coordinate position of each point in the space formed by the second voxel.

13. The method of claim 1, wherein the point cloud data represents an object in a surrounding space acquired through light detection and ranging (LiDAR) and the intensity of a light pulse reflected by the object.

14. The method of claim 1, wherein
a position of the first voxel in a multidimensional space is different than a position of the second voxel in the multidimensional space, and
an intensity of the first key point is different than an intensity of the second key point.

15. A non-transitory computer-readable storage medium storing instructions that, when executed by one or more processors, configure the one or more processors to perform the method of claim 1.

16. An electronic device comprising:
one or more processors configured to:
determine either one or both of a first voxel and a first key point of point cloud data; and
by performing feature transformation on the first voxel and/or the first key point through a neural network, determine either one or both of a second voxel and a second key point of the point cloud data,
wherein a voxel feature of the first voxel is different from a voxel feature of the second voxel, a key point feature of the first key point is different from a key point feature of the second key point, and either one or both of the second voxel and the second key point are used for training of the point cloud data.

17. The electronic device of claim 16, wherein
the neural network is implemented using an encoder and a decoder, and
the one or more processors are configured to:
by performing feature encoding on either one or both of the first voxel and the first key point through the encoder, determine either one or both of the voxel feature of the first voxel and the key point feature of the first key point; and
by performing feature decoding on either one or both of the voxel feature of the first voxel and the key point feature of the first key point through the decoder, determine either one or both of the second voxel of the point cloud data and the second key point of the point cloud data.

18. The electronic device of claim 17, wherein
the encoder comprises a first encoder, and
the one or more processors are configured to:
for each first voxel, by performing a convolution operation on the first voxel by using the first encoder, determining a first intermediate feature of the first voxel; and
by downsampling the first intermediate feature, determine the voxel feature of the first voxel.

19. The electronic device of claim 17, wherein
the encoder comprises a first encoder, and
the one or more processors are configured to:
for each first voxel, determine the first key point corresponding to the first voxel; and
perform feature encoding on the first voxel, based on the key point feature of the first key point, through the first encoder.

20. The electronic device of claim 17, wherein
the encoder comprises a second encoder, and
the one or more processors are configured to:
for each first key point, determine a space comprising the first key point in the point cloud data; and
by performing feature encoding on points in the space by using the second encoder, determine the key point feature of the first key point.
